(19) United States
(12) Patent Application Publication
(10) Pub. No.: US 2008/0147677 A1
(43) Pub. Date: Jun. 19, 2008

(54) Annotation management program, device, method, and annotation editing program, device, method

(75) Inventors: Fumihito Nishino, Kawasaki (JP); Terunobu Kume, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/983,089

(22) Filed: Nov. 7, 2007

(30) Foreign Application Priority Data
Dec. 13, 2006 (JP) 2006-336142

(51) Int. Cl. G06F 17/30

(52) U.S. Cl. 707/10; 707/E17.116; 707/E17.032

(57) ABSTRACT

A management module of an annotation server receives annotation data, which contains location information of web page data, content information of an annotation, and position information of an object to which the annotation is linked, from a web client machine together with a registration request. Then, the management module issues an annotation ID. The module retrieves a text, which consists of an object to which the annotation is linked and an adjacent part that has a relationship satisfying a predetermined condition with the object, as context information from a source text of the web page. Then, the module registers the context information together with the annotation data that is received in advance into an annotation database.

### BACKGROUND OF THE INVENTION

The present invention relates to a program, a device, and a method for managing annotation data, and to a program, a device, and a method for editing an annotation.

As everyone knows, an annotation in a book is information about an interpretation of a phrase in a body and information about a reference document that are described in a page corner or in a chapter end. On the other hand, an annotation in web page data is attendant information that is linked to a part (a character string, an image) in a web page without reference to a source text by a technique such as XLink (XML Linking Language).

With the annotation technique, an annotation server is introduced in a network apart from a web server, and a program for an annotation is installed into a web client as extension. When a part on a web page displayed by a web client program (a web browser) is selected and contents that should be linked to the selected part is inputted as an annotation, the extension concerned notifies the input contents, the position information of the part linked to the contents, and the location information of the web page data to the annotation server. When receiving the contents, position information, and location information, the annotation server issues a unique annotation ID (Identification), and registers it to an annotation database as annotation data in association with the contents, position information, and location information of the annotation. When the web client acquires web page data from the web server, the extension concerned inquires about the presence or absence of annotation data linked to the web page. If the annotation exists, the extension acquires the annotation data from the annotation server and superimposes the annotation over the web page. The extension concerned requires the annotation server to delete the annotation that is selected by an operator among annotations linked to a web page according to a direction of the operator.

In the conventional annotation technique, a user at a web client side can link static information to a part of a web page that cannot be edited at the web client side. That is, a person who is completely different from an administration of a web page can link and delete an annotation independently of uploading a web page to the Internet, deleting it, and changing its contents.

The position information included in annotation data is often defined as abstract information that logically specifies a position of an object (a character string) to which an annotation is linked. For example, the position information is described in Xpath (XML Path Language). Such position information may be information that specifies a root and a node of each block, or a block ID that is uniquely assigned to each block. Blocks are related to one another in a tree structure in a source text. Each block is a section between a start tag and an end tag of the same element. For example, a section between the start tag <body> and the end tag </body> is one block.

Japanese patent publication 3771831 and Japanese unexamined patent publication 2004-046745 disclose such a conventional annotation technique.

Incidentally, a third party can use the annotation to point out a mistake and a misprint of a text on a web page to an administrator of the web page. For example, when it is a general knowledge that “document” is not usually used as an object of “write” and is usually used as an object of “produce”, a third party (of course, restricted to those who have a utilization right of the annotation service) can point out that the sentence “She wrote documents.” on a web page contains a mistake by linking the annotation to the position of the word “wrote” that indicates “You should use ‘produce’ in place of ‘write’”.

If the administrator who noticed the annotation changes “documents” to “letters”, a user who watches the web page after the change feels no sense of incongruity because it is general to use “letter” as an object of “write”. On the other hand, since the position information of the annotation is abstract information as described above, the annotation is displayed in relation to the word “wrote”. Therefore, the annotation that says “You should use produce in place of write” is associated to the word “wrote” in the sentence “She wrote letters”. However, a user cannot understand why such an annotation is associated with the word “wrote”.

Thus, in the conventional annotation technique, when the administrator of an web page changes a part close to an object (character string) to which an annotation is linked, a user may not be able to understand the relationship between the contents of the annotation and the contents of the object.

The problem comes up not only when a third party grasps contents of an annotation on a web page, but also when an annotation is retrieved from an annotation database and is analyzed. For example, at a time of registration of an annotation, if the annotation data includes an object (character string) as relation place information in addition to position information of an annotation, the annotation can be analyzed by comparing contents of relation place information (contents of an object) in the annotation data with contents of the annotation. However, even in this case, since the relationship between the annotation and the object cannot be understood based on the contents thereof, it may be impossible to analyze the annotation.

### SUMMARY OF THE INVENTION

The present invention is developed in view of the above-mentioned problems of the conventional technique. An object of the present invention is to enable a user to understand a relationship between contents of an annotation and contents of an object linked to the annotation.

In order to achieve the above-mentioned object, an annotation management program according to the present invention controls a computer to execute functions including:

a receiving function for receiving annotation data, which includes location information about web page data, content information for specifying an annotation related with a web page corresponding to the web page data, and position information for specifying a position to which the annotation is linked on the web page, from a web client through a communication device;

an acquisition function for acquiring, when the receiving function receives the annotation data, web page data that is specified by the location information in the annotation data from a web server through the communication device;

a retrieval function for retrieving an adjacent part as context information that has a relationship satisfying a predetermined condition with an object at the position specified by the position information in the annotation data that is received by the receiving function from a source text of the web page corresponding to the web page data acquired by the acquisition function; and

a registration function for registering the context information retrieved by the retrieval function in addition to the annotation data received by the receiving function into an annotation database within a storage device.

With this configuration, when receiving the location information of a web page data, the content information of an annotation, and the location information on the object to which the annotation is linked, the computer retrieves an object to which the annotation is linked and an adjacent part that has a relationship satisfying a predetermined condition with the object as context information from a source text of the web page. Further, the computer registers the retrieved context information in addition to the annotation data received in advance into the annotation database. Thereby, when contents of the annotation are compared with contents of the object for each piece of annotation data within the annotation database, a user can understand the relationship between them on the basis of the context information corresponding to the annotation data. The context information can be displayed in a web client when the annotation is displayed over the web page. In such a case, a user can understand the relationship between contents of an annotation and contents of an object through the context information even if the administrator of the web page changes a part close to the object to which the annotation is linked.

In order to achieve the above-mentioned object, an annotation edit program of a first aspect according to the present invention controls a computer to execute functions including:

a first receiving function for receiving location information of web page data from an operator through an input device;

an acquisition function for acquiring web page data that is specified by the location information received by the first receiving function from a web server through a communication device;

a second receiving function for receiving a specification of an object to which an annotation should be linked in the web page corresponding to the web page data acquired by the acquisition function from the operator through the input device;

a third receiving function for receiving contents of the annotation that is linked to the object specified by the specification received by the second receiving function from the operator through the input device;

a retrieval function for retrieving an object that is specified by the specification received by the second receiving function and an adjacent part that has a relationship satisfying a predetermined condition with the object as context information from a source text of the web page corresponding to the web page data acquired by the acquisition function; and

a sending function for sending annotation data, which includes the location information that is received by the first receiving function, the position information of the object that is specified by the specification received by the second receiving function, the content information that specifies contents of the annotation that is received by the third receiving function, and the context information that is retrieved by the retrieval function, to an annotation server through the communication device.

With this configuration, receiving location information of a web page data from an operator, the computer acquires the web page data from the web server. Further, when receiving a specification of an object to which annotation is to be linked in the web page corresponding to the web page data, and contents of the annotation, the computer retrieves a text that consists of the object to which the annotation is linked and an adjacent part that has a relationship satisfying a predetermined condition with the object as context information from a source text of the web page. Then, the computer sends the annotation data to the annotation server. The annotation data includes the retrieved context information in addition to the location information, the position information of the object, and the content information for specifying the contents of the annotation that are received in advance. At the moment, receiving the annotation data from the computer, the annotation server can register the annotation data into the annotation database. Thereby, when contents of the annotation are compared with contents of the object for each piece of annotation data within the annotation database, a user can understand the relationship between them on the basis of the context information corresponding to the annotation data. The context information can be displayed in a web client when the annotation is displayed over the web page. In such a case, a user can understand the relationship between contents of an annotation and contents of an object through the context information even if the administrator of the web page changes a part close to the object to which the annotation is linked.

In order to achieve the above-mentioned object, an annotation edit program of a second aspect according to the present invention controls a computer to execute functions including:

a first receiving function for receiving location information of web page data from an operator through an input device;

an acquisition function for acquiring web page data that is specified by the location information received by the first receiving function from a web server through a communication device;

a second receiving function for receiving a specification of an object to which an annotation should be linked in the web page corresponding to the web page data acquired by the acquisition function from the operator through the communication device;

a third receiving function for receiving contents of the annotation that is linked to the object specified by the specification received by the second receiving function from the operator through the input device;

a fourth receiving function for receiving a text as context information selected from the web page corresponding to the web page data acquired by the acquisition function from the operator through the input device;

a sending function for sending annotation data, which includes the location information that is received by the first receiving function, the position information of the object that is specified by the specification received by the second receiving function, the content information that specifies contents of the annotation that is received by the third receiving function, and the context information that is received by the fourth receiving function, to an annotation server through the communication device.

With this configuration, receiving location information of a web page data from an operator, the computer acquires the web page data from the web server. The computer receives a specification of an object to which the annotation is linked in the web page corresponding to the web page data, and the contents of the annotation, respectively. Then, receiving the text selected from the web page as the context information, the computer sends the annotation data to the annotation server. The annotation data includes the retrieved context information in addition to the location information, the position information of the object, and the content information for specifying the contents of the annotation that are received in advance. At the moment, receiving the annotation data from the computer, the annotation server can register the annotation data into the annotation database. Thereby, when contents of the annotation are compared with contents of the object for each piece of annotation data within the annotation database, a user can understand the relationship between them on the basis of the context information corresponding to the annotation data. The context information can be displayed in a web client when the annotation is displayed over the web page. In such a case, a user can understand the relationship between contents of an annotation and contents of an object through the context information even if the administrator of the web page changes a part close to the object to which the annotation is linked.

Therefore, according to the present invention, a relationship between contents of an annotation and contents of an object to which the annotation is linked can be understood by an annotation user.

### DESCRIPTION OF THE ACCOMPANYING DRAWINGS

FIG. 1 shows a system configuration of a computer network system of a first embodiment.

FIG. 2 is a flowchart showing a part of a process by an edit module program according to the first embodiment,

FIG. 3 is a flowchart showing the other part of a process by the edit module program according to the first embodiment,

FIG. 4 is a flowchart showing a process by a management module program according to the first embodiment,

FIG. 5 is a flowchart showing a process by a context information acquisition subroutine according to the first embodiment,

FIG. 6 shows an example of a source text of a web page,

FIG. 7 shows an example of a data structure of a definition table,

FIG. 8 shows a system configuration of a computer network system of a second embodiment,

FIG. 9 is a flowchart showing a part of a process by an edit module program according to the second embodiment,

FIG. 10 is a flowchart showing a process by a context information acquisition subroutine according to the second embodiment,

FIG. 11 is a flowchart showing a process by a management module program according to the second embodiment,

FIG. 12 shows a system configuration of a computer network system of a third embodiment, and

FIG. 13 is a flowchart showing a process by a context information acquisition subroutine according to the third embodiment.

### DESCRIPTION OF THE PREFERRED EMBODIMENTS

Hereafter, three embodiments of the present invention will be described with reference to the accompanying drawings.

### First Embodiment

First, a hardware configuration and a software configuration of the computer network system according to the first embodiment will be described.

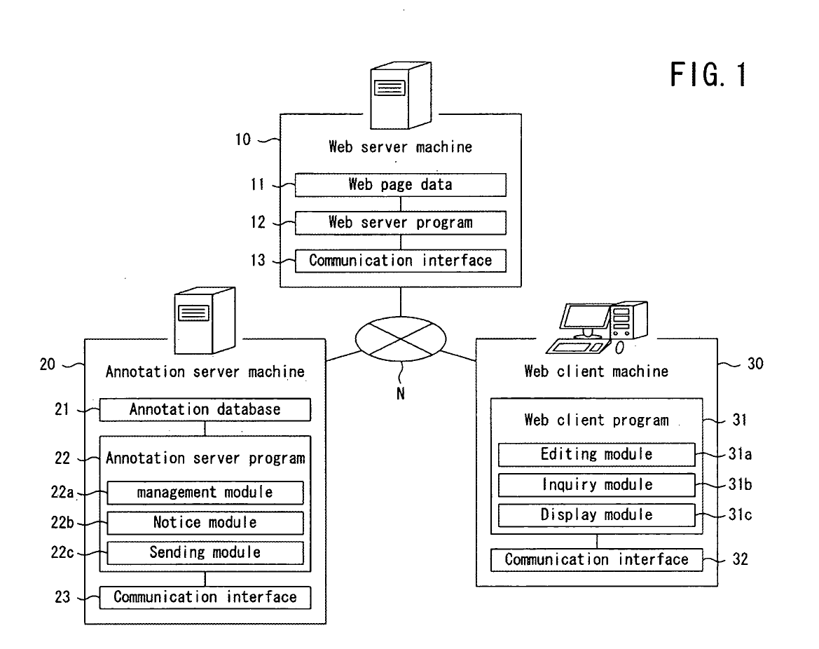

FIG. 1 shows a system configuration of a computer network system of the first embodiment.

The computer network system of the first embodiment consists of a web server machine 10, an annotation server machine 20, and a web client machine 30. The machines 10, 20, and 30 are connected via a network N so that they can communicate mutually.

The web server machine 10 is a general purpose computer to which a function as a web server is added. Therefore, the web server machine 10 contains at least storage, a CPU (Central Processing Unit), a DRAM (Dynamic Random Access Memory), and a communication adapter that are not illustrated. The storage stores various kinds of application programs and data. The CPU is a processing unit that processes according to a program within the storage. The DRAM is a volatile memory device to which a program is cashed and workspace is developed when the CPU processes. The communication adapter is a communication device that exchanges data with other computers on the network N.

The storage of the web server machine 10 stores web page data 11, a web server program 12, and a communication interface program 13. The web page data 11 is HTML (HyperText Markup Language) data that is provided to other computers through the network N. A unique URL (Uniform Resource Locator) is assigned to each the web page data 11 as location information. Receiving an HTTP (HyperText Transfer Protocol) request message with specification of URL from a web client machine (not shown), the web server program 12 sends an HTTP response message containing web page data 11 of the web page defined by the URL. The communication interface program 13 is a protocol stack (program) for exchanging the data with other computers through the network N according to TCP/IP (Transmission Control Protocol/Internet Protocol).

The annotation server machine 20 is a general purpose computer to which a function of the annotation server is added. Therefore, the annotation server machine 20 contains at least a hard disk, a CPU, a DRAM, and a communication adapter that are not illustrated.

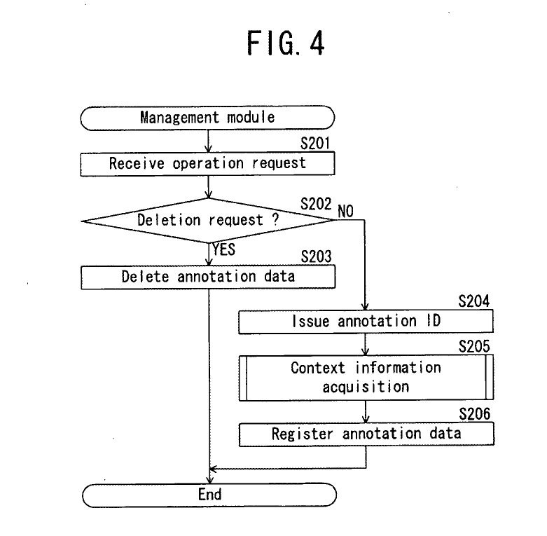

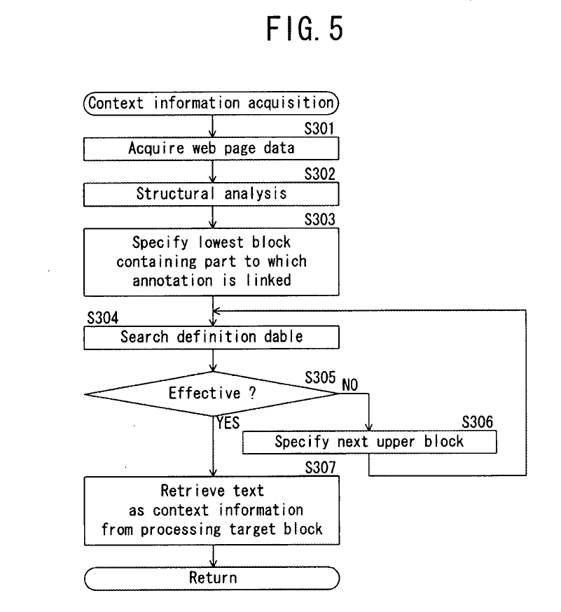

The hard disk of the annotation server machine 20 stores an annotation database 21, an annotation server program 22, and a communication interface program 23. Here, an annotation is attendant information that is linked to a part (a character string, an image) in a web page without reference to a source text by a technique such as XLink (XML Linking Language). The annotation database 21 is a function (table group and program group) for storing annotation data with enabling free search. The annotation data includes at least location information (URL) of web page data, position information for specifying a position to which the annotation is linked on the web page, content information for specifying contents of the annotation, information about creation of the contents (a creator, a date and time of creation, etc.), and an annotation ID (Identification) for specifying each annotation individually. The position information included in the annotation data may be information that specifies routes and nodes of each of blocks related in a tree structure in a source text, like the information described according to Xpath (XML Path Language), for example. Alternatively, the position information may be a block ID (Identification) that is uniquely assigned to each block. Anyway, the annotation data uses the abstract information that logically specifies the position of an object (character string) to which the annotation is linked as the position information. The annotation server program 22 is used to execute the process about an annotation at the server side. The annotation server program 22 contains a management module program 22a, a notice module program 22b, and a sending module program 22c. The management module program 22a is used to register or delete the annotation data with respect to the annotation database 21 according to an operational direction from the web client machine 30. The notice module program 22b is used to notify the presence or absence of the annotation data that meets a predetermined condition in the annotation database 21 in response to a request from the web client machine 30. The sending module program 22c is used to send annotation data from the annotation database 21 to the web client machine 30 in response to a request from the web client machine 30. The processes executed by the CPU (not shown) according to the management module program 22a will be described below with reference to FIG. 4 and FIG. 5. The communication interface program 23 is a TCP/IP stack as in the case of the web server machine 10.

The web client machine 30 is a personal computer to which the function of the web client is added. Therefore, the web client machine 30 consists of a display such as a liquid crystal display, input devices such as a keyboard and a mouse, and a main body to which these devices are connected. The main body contains storage, a CPU, a DRAM, and a communication adapter.

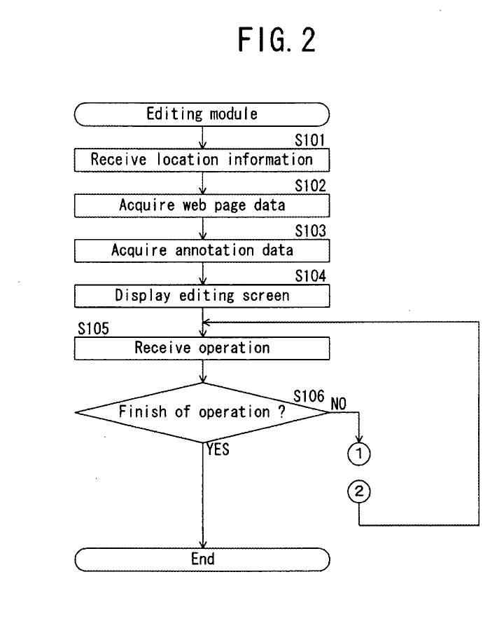

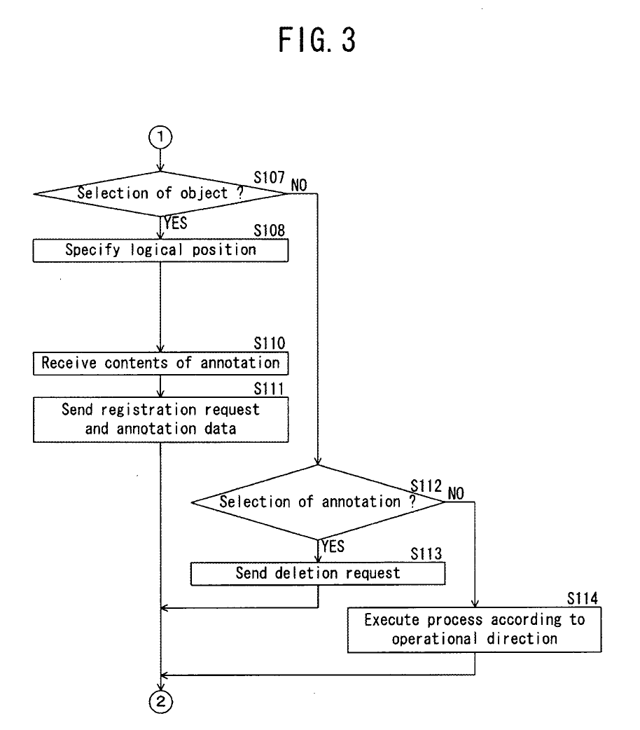

The storage of the web client machine 30 stores a web client program 31, and a communication interface program 32. The web client program 31 is used to acquire the web page data in the web server machine 10 through the exchange of HTTP messages with the web server (function based on a program) 12, and to display the web page on the display. The web client program 31 contains an editing module program 31a, an inquiry module program 31b, and a display module program 31c as module programs for extensions. The editing module program 31a is used to send the operational direction about registration or deletion of the annotation data to the management module (function based on a program) 22a of the annotation server (function based on a program) 22. Regarding the registration of annotation data, the editing module program 31a generates annotation data and delivers it to the management module 22a. The inquiry module program 31b is used to inquire whether the annotation data that meets a predetermined condition is registered after the notice module (function based on a program) 22b of the annotation server program 22. The display module program 31c is used to acquire annotation data from the sending module (function based on a program) 22c and to display an annotation over a web page. The processes executed by the CPU (not shown) according to the editing module program 31a will be described below with reference to FIG. 2 and FIG. 3. The communication interface program 32 is a TCP/IP stack as in the case of the web server machine 10.

Next, the process concerning generation and registration of annotation data is described.

First, when a predetermined operation is inputted to the web client machine 30 through the input device, the editing module program 31a starts.

FIG. 2 and FIG. 3 are flowcharts showing processes by the editing module program 31a.

The editing module (the CPU (not shown) that executes a program) 31a receives location information (URL) of a web page from an operator through an input screen or the like in a first step S101.

In the next step S102, the editing module 31a acquires the web page data that is specified by the location information received at step S101 from the web server (the CPU (not shown) that executes a program) 12.

In the next step S103, the editing module 31a acquires all pieces of the annotation data that include the location information received in step S101 from the annotation server (the CPU (not shown) that executes a program) 22.

In the next step S104, the editing module 31a displays an edit screen on the display. The web page based on the web page data acquired in step S102 and the annotation based on the annotation data acquired in step S103 are displayed in the edit screen. The annotation is displayed with relating to the position that is specified by the position information included within the annotation data.

In the next step S105, the editing module 31a receives an operational direction from the operator through an input device. The operational direction may be a registration of an annotation, a deletion of an annotation, a finish of operation, or another operation. The operational direction for the registration of an annotation is a selection of the object displayed on the edit screen by a click or the like. The operational direction for the deletion of an annotation is a selection of the annotation displayed on the edit screen by a click or the like. The operational direction for the finish of operation is a click of a close button of the window, or a selection of an application finish menu. Another operational direction is, for example, a menu selection.

In the next step S106, the editing module 31a determines whether the operational direction received in step S105 is the finish of operation. When the operational direction is the finish of operation, the editing module 31a finishes the process concerning FIGS. 2 and 3. On the other hand, when the operational direction is not the finish of operation, the editing module 31a branches the process from step S106 to step S107.

In step S107, the editing module 31a determines whether the operational direction received in step S105 is a selection of the object on the edit screen. When the operational direction is a selection of the object on the edit screen, the editing module 31a advances the process to step S108.

In the next step S108, the editing module 31a specifies a logical position of the object, which is selected by the operational direction received in step S105, on the web page. Specifically, the editing module 31a first specifies the respective blocks (the part sandwiched between a start tag and an end tag of the same element like <body> and </body> is one block) that are related in a tree structure in a source text of the web page data. Then, the module 31a generates information that specifies each block (information to specify routes and nodes, or a block ID (Identification) that is unique for each block) to analyze the configuration of the web page data. Next, the editing module 31a specifies the block that is specified by the specification received in step S108. Then, the module 31a defines the information that specifies the block as the target position information. For example, the position information may be expressed by Xpath like “/HTML/BODY/TABLE/TR/TD 0”.

In the next step S110, the editing module 31a receives the contents of the annotation through the input device from the operator.

In the next step S111, the editing module 31a generates annotation data including the position information of the logical position specified in step S108 and the content information received in step S110, and sends the annotation data and a registration request to the management module (function based on a program) 22a of the annotation server (function based on a program) 22. After sending the registration request, the editing module 31a returns the process to step S105.

In step S107, when the operational direction received in step S105 is not a selection of the object on the edit screen, the editing module 31a branches the process from step S107 to step S112.

In step S112, the editing module 31a determines whether the operational direction received in step S105 is a selection of the annotation on the edit screen. When the operational direction is a selection of the annotation on the edit screen, the editing module 31a advances the process to step S113.

In step S113, the editing module 31a sends the annotation ID of the annotation that is selected when the operational direction was received in step S105. At the same time, the editing module 31a sends a deletion-request for the annotation to the management module 22a. Then, the editing module 31a returns the process to step S105.

In step S104, when the operational direction received in step S105 is not a selection of the annotation, the editing module 31a branches the process from step S112 to step S114.

In step S114, the editing module 31a executes a process according to the operational direction received in step S105, and then, returns the process to step S105.

According to the process of the editing module 31a, the operator of the web client machine 30 can direct a registration and a deletion of an annotation to the annotation server 22.

FIG. 4 is a flowchart showing a process by the management module program 22a within the annotation server program 22.

The management module program 22a is executed by the CPU (not shown) after starting the annotation server machine 20. In a first step S201, the management module (the CPU (not shown) that executes a program) 22a waits until receiving an operation request from the editing module 31a of any of web client machines 30. When receiving an operation request from any of web client machines 30, the management module 22a advances the process to step S202. The CPU (not shown) that executes the process in step S201 corresponds to the receiving function mentioned above.

In step S202, the management module 22a determines whether the operation request received in step S201 is a deletion request. When the operation request received in step S201 is a deletion request, the management module 22a advances the process to step S203.

In step S203, the management module 22a deletes the annotation data, which corresponds to the annotation ID that is received with the deletion request in step S201, from the annotation database 21. A deletion of an annotation may be a change of status of the annotation data within the annotation database 21 to deletion status. Here, the deletion status means the condition to prohibit from sending the annotation data when the display module (function based on a program) 31 requests it, and does not mean the condition to delete the annotation data from the annotation database 21. The condition can be managed by a flag, for example. Then, the management module 22a finishes the process shown in FIG. 4.

On the other hand, in step S202, when it is determined that the operation request received in step S201 is not a deletion request but a registration request, the management module 22a branches the process from step S202 to step S204.

In step S204, the management module 22a issues a new annotation ID to the annotation data that is received in step S201 with the registration request.

In the next step S502, the management module 22a executes a context information acquisition subroutine.

FIG. 5 is a flowchart showing a process of the contest information acquisition subroutine.

At a first step S301, the management module 22a retrieves location information from the annotation data that is received in step S201 with the registration request. And then, acquires web page data that is specified by the retrieved location information from the web server (function based on a program) 12. The CPU (not shown) that executes the process in step S301 corresponds to the acquisition function mentioned above.

In the next step S302, the management module 22a analyzes the structure of the web page data acquired in step S301. The structural analysis of the web page data has been already described in the explanation about step S108 in FIG. 3.

In the next step S303, the management module 22a specifies the lowest block containing a part to which the annotation is linked, on the basis of the position information within the annotation data that is received in step S201. The hierarchy of a block is mentioned later. Then, the management module 22a advances the process to step S304 by making the specified block into a processing target.

In step S304, the management module 22a searches a definition table using elements of the start tag and the end tag of the processing target block as keys. Before describing the definition table, a configuration of a source text of a web page is briefly described.

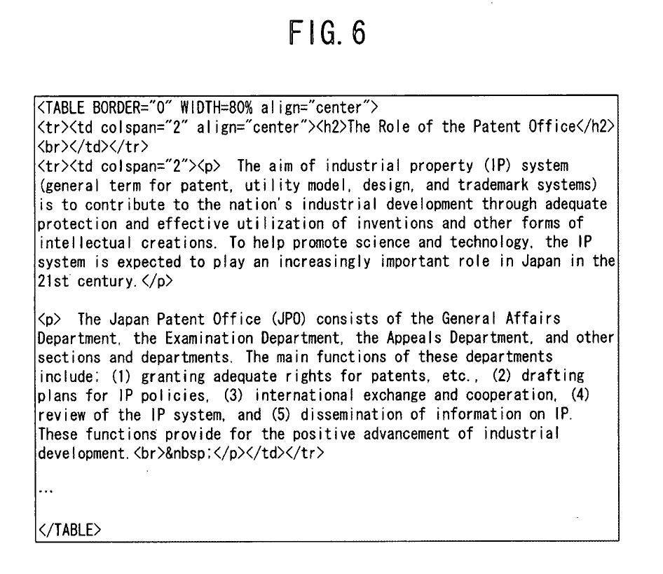

FIG. 6 shows an example of a source text of a web page.

The source text of the web page shown in FIG. 6 includes character string “(1) granting adequate rights for patents, etc.”. The lowest block containing the character string concerned is “<p> The Japan Patent Office (JPO) consists of . . . advancement of industrial development.<br>&nbsp;</p>”. The next upper block of the block concerned is “<td colspan=“2”> <p> The aim of industrial property (IP) system . . . in Japan in the 21st century.</p> <p> The Japan Patent Office (JPO) consists of . . . advancement of industrial development. <br>&bnsp;</p></td>”. That is, in the web page of FIG. 6, since the start tag and the end tag that are closest to the above-mentioned character string are <p> and </p>, the block between the start tag <p> and the end tag </p> is the lowest block for the above-mentioned character string. The block between the start tag <p> and then end tag </p> is included in a block between the start tag <td colspan=“2”> and the end tag </td>. Therefore, this block is the next upper block of the lowest block. Thus, a character string on a web page is included in a certain block on a source text.

On the other hand, a source text of a web page can include an element that cannot define a block and an element that is unworthy of adopting as a block. For example, “<hr>” and “<img>” (not show in FIG. 6) are the elements that cannot define a block because they do not require the end tags. Further, for example, “<ruby>, </ruby>” and “<sup>, </sup>” (not shown in FIG. 6) are the elements that are unworthy of adopting as a block because they specify display patterns of characters.

Under the above premises, the information recorded in the definition table with enabling free search defines tags that construct a block that should be adopted as a target of the later process among blocks that are related in a tree-structure in a source text as shown in FIG. 6. The information in the definition table also defines tags that construct a block that should not be adopted as a processing target.

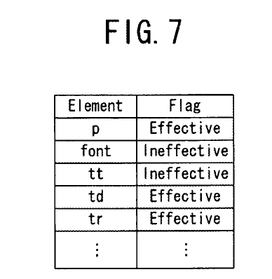

FIG. 7 shows an example of a data structure of the definition table.

As shown in FIG. 7, specifically, each record of the definition table has fields of an “element” and a “flag”. The “element” field stores a name of an HTML element, and the “flag” field stores a flag that determines whether the block defined by the element is effective or ineffective as a processing target. The flags are set up by the administrator in advance. Since the definition table has such a field configuration, an operator can determine which block defined by the elements can be used as a processing target based on the definition table.

Although the elements of the HTML tags are registered into the definition table shown above, the elements are not limited to them. For example, an element of a part-of-speech tag may be registered into the definition table. A part-of-speech tag is used by a well-known structural analysis tool to pack a word, a phrase, or an idiom in a source text of a web page into a block. The structural analysis tool inserts a part-of-speech tag ahead or behind a word, a phrase, or an idiom. When using the definition table in which the elements of part-of-speech tags are registered, the management module 22a needs to make a well-known structural analysis tool execute the process to insert a part-of-speech tag to the source text of the web page just before executing the structural analysis in step S302.

In step S304, the management module 22a searches the definition table as shown in FIG. 7, and then, advances the process to step S305.

In step S305, the management module 22a determines whether the flag in the record detected by the search in step S304 is effective or ineffective. When the flag in the detected record is ineffective, the management module 22a branches the process from step S305 to step S306.

In step S306, the management module 22a specifies the block that is next upper than the processing target block at this time. Then, the management module 22a advances the process to step S304.

On the other hand, in step S305, when the flag in the record detected by the search in step S304 is effective, the management module 22a advances the process to step S307.

In step S307, the management module 22a retrieves a text included in the processing target block as context information. Then, the management module 22a finishes the context information acquisition subroutine of FIG. 5, and advances the process to step S206 in FIG. 4. The CPU (not shown) that executes the process in steps S302 through S307 corresponds to the retrieval function mentioned above.

In step S206, the management module 22a adds the context information acquired in step S205 to the annotation data received in step S201, and registers them into the annotation database 21. Then, the management module 22a finishes the process shown in FIG. 4. The CPU (not shown) that executes the process in step S206 corresponds to the registration function mentioned above.

Next, an operation and an effect of the computer network system of the first embodiment will be described.

When the operator of the web client machine 30 starts the editing module program 31a by operating the input device (not shown) and inputs location information of a web page data, an edit screen is displayed on the display (not shown) (S101 through S104). In the edit screen, the web page specified by the operator and the annotation linked to the web page are displayed.

If the operator specifies any part of the web page in the edit screen and inputs contents of an annotation after inputting the operational direction of registration, the annotation data is sent to the annotation server 22 (S105 through S108, S110, S111).

Receiving the annotation data, the management module 22a of the annotation server 22 acquires the web page data specified by the location information in the annotation data. Then, the management module 22a retrieves a text that consists of the object to which the annotation is linked and an adjacent part that has a relationship satisfying a predetermined condition with the object as context information from the source text of the web page corresponding to the web page data (S201, S202, S204, and S205). Then, the management module 22a registers the context information retrieved and the annotation data received in advance into the annotation database 21 (S206).

Since the annotation server 22 operates as mentioned above, the context information corresponding to the content information as well as the annotation data is registered into the annotation database 21. Thereby, when contents of the annotation are compared with contents of the object for each piece of annotation data in the annotation database 21, the operator can understand the relationship between them on the basis of the context information corresponding to the annotation data.

Further, the context information can be displayed in the web client machine 30 when the annotation is displayed over the web page. In such a case, the operator of the web client machine 30 can understand the relationship between contents of an annotation and contents of an object through the context information even if the administrator of the web page changes a part close to the object to which the annotation is linked.

### Second Embodiment

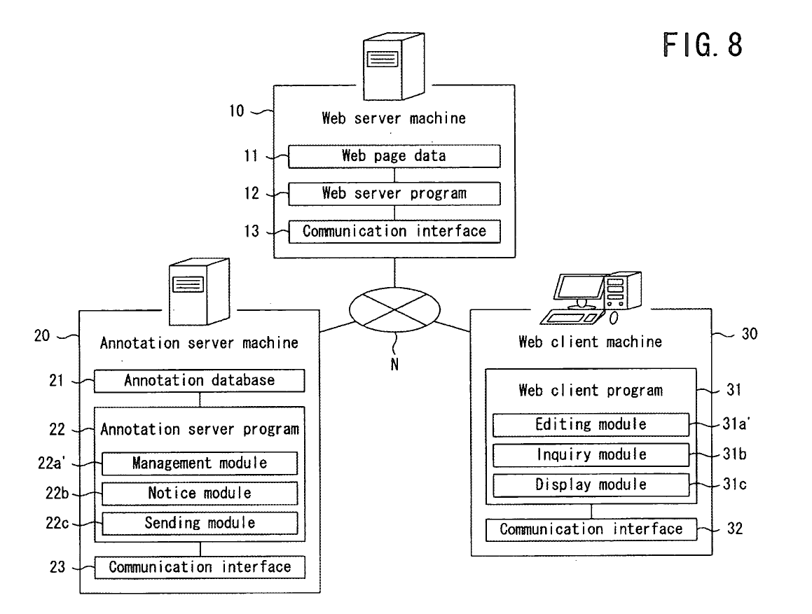

FIG. 8 shows a system configuration of a computer network system of the second embodiment.

The context information acquisition process (the process in step S206 of FIG. 4, i.e., the subroutine of FIG. 5) is executed in the web client machine 30 but not the annotation server machine 20. This is a different point from the first embodiment. However, the other configurations in hardware and software are basically identical to those of the first embodiment. As is evident from a comparison between FIG. 8 and FIG. 1, a reference letter of the management module program of the annotation server machine 20 and a reference letter of the editing module program of the web client machine 30 in the second embodiment are different from those in the first embodiment. That's because, the contents of the processes of the management module program 22a′ and the editing module program 31a′ in the second embodiment are slightly different from those in the first embodiment.

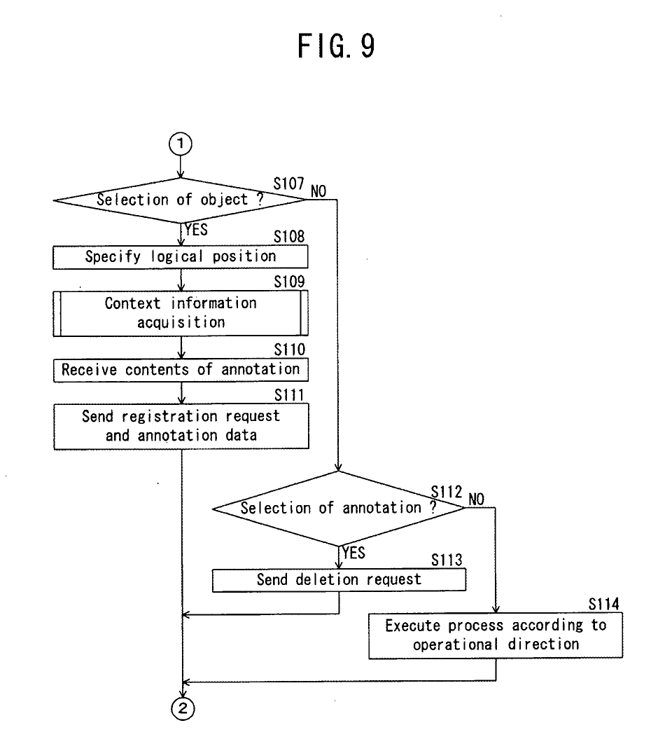

FIG. 9 is a flowchart showing the process by the editing module program 31a′. The flow of the process other than the section shown in FIG. 9 is common to the section shown in FIG. 2. That is, the flow of process by the editing module program 31a′ in the second embodiment is a combination of the process in FIG. 2 and the process of FIG. 9.

As shown in FIG. 2, after starting, the editing module (the CPU (not shown) that executes a program) 31a′ receives location information (URL) of web page data from an operator through an input screen etc. (Step S101). Then, the module 31a′ acquires the web page data specified by the location information from the web server (the CPU (not shown) that executes a program) 12 (S102). The module 31a′ also acquires annotation data of all the annotations that contain the location information from the annotation server (the CPU (not shown) that executes a program) 22 (S103). The CPU (not shown) that executes step S101 corresponds to the first receiving function mentioned above, and the CPU that executes step S102 corresponds to the acquisition function mentioned above.

Then, the editing module 31a′ displays an edit screen on the display (S104). When receiving an operational direction from the operator through the input device (S105), the editing module 31a′ distinguishes the type of the received operational direction (S106, S107, S112). When the operational direction is a selection of the object on the edit screen (the case of the operational direction of registration of an annotation), the editing module 31a′ advances the process to step S108 in FIG. 9. When the operational direction is a selection of the annotation on the edit screen (the case of the operational direction of deletion of an annotation), the editing module 31a′ advances the process to step S113 in FIG. 9.

When the operational direction is a selection of the object on the edit screen (the case of the operational direction of registration of an annotation, S107; YES), the editing module 31a′ specifies the logical position of the object that is specified by the operational direction in the web page data (S108). Therefore, the CPU (not shown) that executes the process in step S105 corresponds to the second receiving function mentioned above.

After that, the process to receive the contents of the annotation (S110) is executed in the first embodiment. On the other hand, in the second embodiment, a context information acquisition subroutine (S109) is executed before that as shown in FIG. 9.

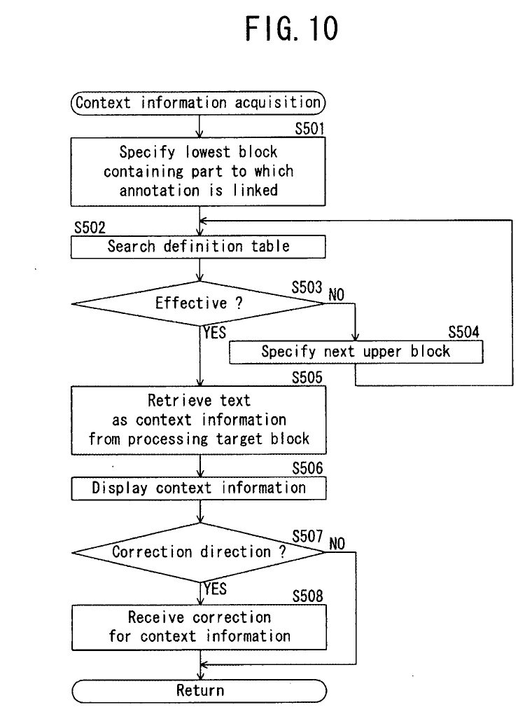

FIG. 10 is a flowchart showing a process by a context information acquisition subroutine according to the second embodiment.

In a first step S501, the editing module 31a′ specifies the lowest block containing a part to which the annotation is linked, on the basis of the position information of the logical position specified in step S108. Then, the editing module 31a′ advances the process to step S502 by making the specified block into a processing target.

In step S502, the editing module 31a′ searches a definition table as shown in FIG. 7 using elements of the start tag and the end tag of the processing target block as keys.

In the next step S503, the editing module 31a′ determines whether the flag in the record detected by the search in step S502 is effective or ineffective. When the flag in the detected record is ineffective, the editing module 31a′ branches the process from step S503 to step S504.

In step S504, the editing module 31a′ specifies the block that is next upper than the processing target block at this time. Then, the editing module 31a′ returns the process to step S502.

On the other hand, in step S503, when the flag in the record detected by the search in step S502 is effective, the editing module 31a′ advances the process to step S505.

In step S505, the editing module 31a′ retrieves a text included in the processing target block as context information. The CPU (not shown) that executes the process in steps S503 through S505 corresponds to the retrieval function mentioned above.

In the next step S506, the editing module 31a′ displays the retrieved context information on the display (not shown).

In the next step S507, the editing module 31a′ determines whether the operator directed a correction of the context information through a dialog box or the like. When the operator did not direct a correction of the context information, the editing module 31a′ branches the process from step S509, finishes the context information acquisition subroutine of FIG. 10, and advances the process to step S110 of FIG. 9. On the other hand, when the operator directed a correction of the context information, the editing module 31a′ advances the process to step S510.

In step S501, the editing module 31a′ receives a correction of the context information through the input device from the operator. Then, the editing module 31a′ finishes the context information acquisition subroutine of FIG. 10, and advances the process to step S110 in FIG. 9.

Acquiring the context information as described above, the editing module 31a′ receives contents of the annotation data (S110). Then, the module 31a′ sends the annotation data and a registration request to the management module (function based on a program) 22a′ of the annotation server (function based on a program) 22 (S111). The annotation data contains the context information and the content information that specifies the contents of the annotation. The CPU (not shown) that executes step S110 corresponds to the third receiving function mentioned above, and the CPU (not shown) that executes step S111 corresponds to the sending function mentioned above.

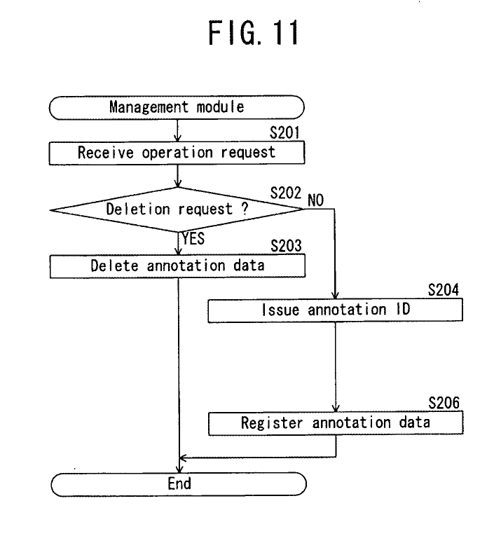

FIG. 11 is a flowchart showing a process by a management module program 22a′ according to the second embodiment.

As is evident from a comparison between FIG. 11 and FIG. 4, the management module program 22a′ in the second embodiment is the same as the management module program 22a except that the program 22a′ does not execute the context information acquisition subroutine (S205 in FIG. 4). Therefore, when receiving the registration request and the annotation data including the context information from the web client 31, the management module 22a′ registers the annotation data into the annotation database 21 as-is. That is, the management module program 22a′ of the second embodiment registers the context information into the annotation database 21. This is a different point from the prior art.

Since the editing module 31a′ and the management module 22a′ operate as mentioned above, the context information corresponding to the content information is registered into the annotation database 21 in the second embodiment. Thereby, when contents of the annotation are compared with contents of the object for each piece of annotation data in the annotation database 21, the operator can understand the relationship between them on the basis of the context information corresponding to the annotation data.

Since the editing module 31a′ acquires context information and displays it on the display, the operator has a chance to correct the context information. Therefore, the operator of the web client machine 30 can register the context information that convinces himself or herself into annotation database 21.

### Third Embodiment

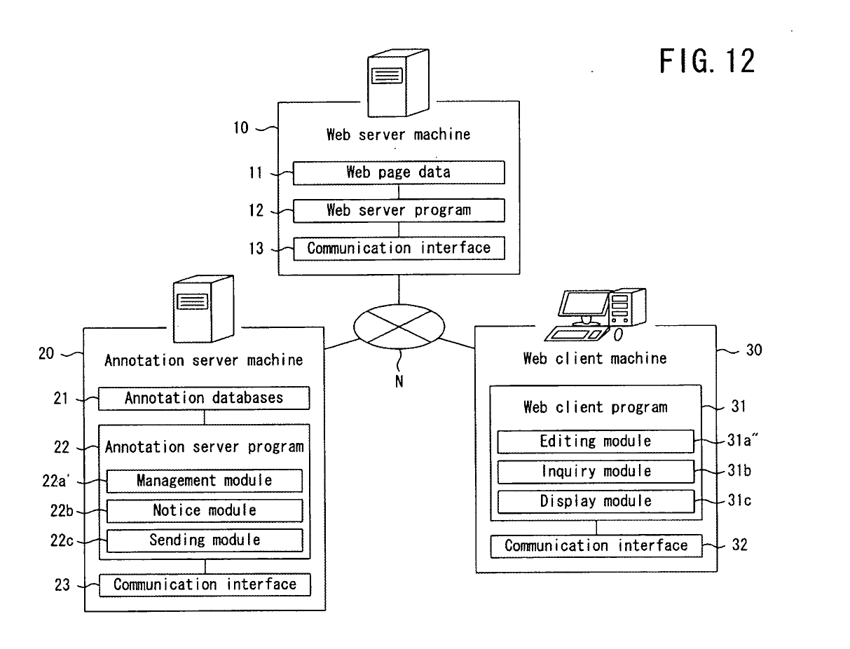

FIG. 12 shows a system configuration of a computer network system of the third embodiment.

In the third embodiment, the annotation server 22 or the web client 31 does not acquire context information automatically. The context information is received from an operator of the web client machine 30. This is a different point from the first and second embodiments. However, the other configurations in hardware and software are basically identical to those of the second embodiment. As is evident from a comparison between FIG. 12 and FIG. 8, a reference letter of the editing module program of the web client machine 30 in the third embodiment is different from that in the second embodiment. That's because, the contents of the process of the editing module program 22a″ in the third embodiment is slightly different from those in the second embodiment.

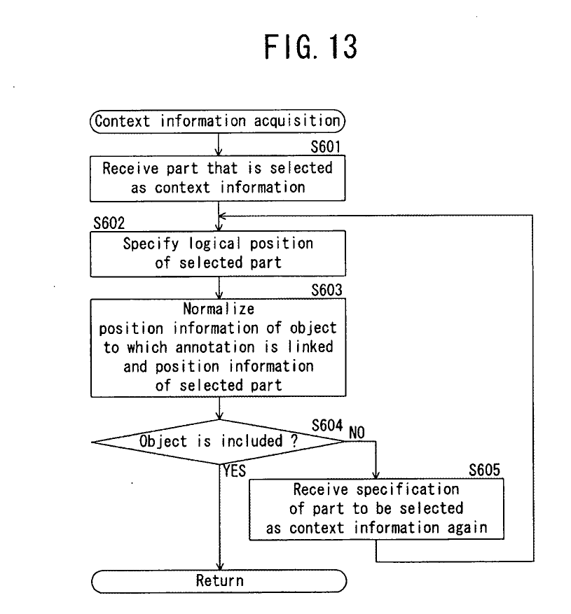

FIG. 13 is a flowchart showing a process by a context information acquisition subroutine according to the third embodiment.

The context information acquisition subroutine shown in FIG. 13 is executed by the editing module 31a″ in step S109 in FIG. 9. That is, the second embodiment and the third embodiment are different about only the contents of the context information acquisition subroutine. Therefore, the management module program 22a″ of the third embodiment also registers the context information into the annotation database 21 like the second embodiment. This is a different point from the prior art.

At a first step S601, the editing module 31a″ receives a specification of a part that is to be selected as context information through an operation such as a drug on the web page displayed on the display. The CPU (not shown) that executes the process in step S601 corresponds to the fourth receiving function mentioned above.

In the next step S602, the editing module 31a″ specifies a logical position of the selected part that is specified by the specification received in step S601. The logical position is specified by using structure information that is analyzed in step S108 in FIG. 9.

In the next step S603, the editing module 31a″ normalizes the selected part and an object based on the position information of the logical position of the selected part specified in step S602 and the position information of the logical position of the part (object) to which the annotation is linked that is specified in step S108 in FIG. 9. For example, the normalization process specifies the address of the first character and the address of the final character in the selected part, and specifies the address of the first character and the address of the final character in the object. An address is the number of characters counted from a head of a source text to the target character.

In the next step S604, the editing module 31a″ determines whether the object is included within the selected part. Specifically, the editing module 31a″ determines whether both of conditions c₁≧a₁ and a₂≦c₂ are satisfied. Where, a₁ is the address of the first character in the object, a₂ is the address of the final character in the object, c₁ is the address of the first character in the selected part, and c₂ is the address of the final character in the selected part. When the object is not included within the selected part, the editing module 31a″ branches the process from step S604 to step S605.

In step S605, the editing module 31a″ receives a specification of a part that is selected as context information from the operator again. Then, the editing module 31a″ returns the process to step S602.

On the other hand, in step S604, when the object is included within the selected part, the editing module 31a″ adopts a text of the selected part at the time as context information, finishes the context information acquisition subroutine of FIG. 13, and advances the process to step S110 in FIG. 9.

Since the editing module 31a operates as described above, the text selected by the operator of the web client machine 30 from the web page is registered together with the annotation data into the annotation database 21 as the context information. Thereby, when contents of the annotation are compared with contents of the object for each piece of annotation data in the annotation database 21, the operator can understand the relationship between them on the basis of the context information corresponding to the annotation data.

The editing module 31a″ judges whether a relationship between the text selected by the operator of the web client machine 30 and the object to which the annotation is linked is appropriate (S603, S604). Therefore, even if the operator of the web client machine 30 has selected inappropriate context information with respect to an object, it is not registered into the annotation database 21 as-is.

What is claimed is:

1. A computer readable medium containing an annotation management program that controls a computer to execute functions comprising:
a receiving function for receiving annotation data, which includes location information about web page data, content information for specifying an annotation related with a web page corresponding to the web page data, and position information for specifying a position to which the annotation is linked on the web page, from a web client through a communication device;
an acquisition function for acquiring, when said receiving function receives the annotation data, web page data that is specified by the location information in the annotation data from a web server through said communication device;
a retrieval function for retrieving an adjacent part as context information that has a relationship satisfying a predetermined condition with an object at the position specified by the position information in the annotation data that is received by said receiving function from a source text of the web page corresponding to the web page data acquired by said acquisition function; and
a registration function for registering the context information retrieved by said retrieval function in addition to the annotation data received by said receiving function into an annotation database in a storage device.

2. An annotation management device comprising:
a receiving section for receiving annotation data, which includes location information about web page data, content information for specifying an annotation related with a web page corresponding to the web page data, and position information for specifying a position to which the annotation is linked on the web page, from a web client through a communication device;
an acquisition section for acquiring, when said receiving section receives the annotation data, web page data that is specified by the location information in the annotation data from a web server through said communication device;
a retrieval section for retrieving an adjacent part as context information that has a relationship satisfying a predetermined condition with an object at the position specified by the position information in the annotation data that is received by said receiving section from a source text of the web page corresponding to the web page data acquired by said acquisition section; and
a registration section for registering the context information retrieved by said retrieval section in addition to the annotation data received by said receiving section into an annotation database in a storage device.

3. A computer readable medium containing an annotation editing program that controls a computer to execute functions comprising:
a first receiving function for receiving location information of web page data from an operator through an input device;
an acquisition function for acquiring web page data that is specified by the location information received by said first receiving function from a web server through a communication device;
a second receiving function for receiving a specification of an object to which an annotation is to be linked in the web page corresponding to the web page data acquired by said acquisition function from the operator through said communication device;
a third receiving function for receiving contents of the annotation that is linked to the object specified by the specification received by said second receiving function from the operator through said input device;
a retrieval function for retrieving an object that is specified by the specification received by said second receiving function and an adjacent part that has a relationship satisfying a predetermined condition with the object as context information from a source text of the web page corresponding to the web page data acquired by said acquisition function; and
a sending function for sending annotation data, which includes the location information that is received by said first receiving function, the position information of the object that is specified by the specification received by said second receiving function, the content information that specifies contents of the annotation that is received by said third receiving function, and the context information that is retrieved by said retrieval function, to an annotation server through said communication device.

4. An annotation editing device comprising:
a first receiving section for receiving location information of web page data from an operator through an input device;
an acquisition section for acquiring web page data that is specified by the location information received by said first receiving section from a web server through a communication device;
a second receiving section for receiving a specification of an object to which an annotation is to be linked in the web page corresponding to the web page data acquired by said acquisition section from the operator through said communication device;
a third receiving section for receiving contents of the annotation that is linked to the object specified by the specification received by said second receiving section from the operator through said input device;
a retrieval section for retrieving an object that is specified by the specification received by said second receiving section and an adjacent part that has a relationship satisfying a predetermined condition with the object as context information from a source text of the web page corresponding to the web page data acquired by said acquisition section; and
a sending section for sending annotation data, which includes the location information that is received by said first receiving section, the position information of the object that is specified by the specification received by said second receiving section, the content information that specifies contents of the annotation that is received by said third receiving section, and the context information that is retrieved by said retrieval section, to an annotation server through said communication device.

5. A computer readable medium containing an annotation editing program that controls a computer to execute functions comprising:
a first receiving function for receiving location information of web page data from an operator through an input device;
an acquisition function for acquiring web page data that is specified by the location information received by said first receiving function from a web server through a communication device;
a second receiving function for receiving a specification of an object to which an annotation should be linked in the web page corresponding to the web page data acquired by said acquisition function from the operator through said communication device;
a third receiving function for receiving contents of the annotation that is linked to the object specified by the specification received by said second receiving function from the operator through said input device;
a fourth receiving function for receiving a text as context information selected from the web page corresponding to the web page data acquired by said acquisition function from the operator through said input device; and
a sending function for sending annotation data, which includes the location information that is received by said first receiving function, the position information of the object that is specified by the specification received by said second receiving function, the content information that specifies contents of the annotation that is received by said third receiving function, and the context information that is received by said fourth receiving function, to an annotation server through said communication device.

6. The computer readable medium according to claim 5 containing an annotation editing program that controls a computer to execute functions further comprising:
a determination function to determine whether the text received by said fourth receiving function as the context information includes the object specified by the specification received by said second receiving function,
wherein said sending function sends the annotation data containing said text as the context information to said annotation server through said communication device, when said determination function determines that said text includes said object.
